(19) United States
(12) Patent Application Publication
(10) Pub. No.: US 2024/0288295 A1
(43) Pub. Date: Aug. 29, 2024

(54) DUST FILTER FOR GAS METER

(71) Applicant: SAGEMCOM ENERGY & TELECOM SAS, BOIS-COLOMBES (FR)

(72) Inventor: Abbas SABRAOUI, BOIS-COLOMBES (FR)

(21) Appl. No.: 18/589,230

(22) Filed: Feb. 27, 2024

(30) Foreign Application Priority Data
Feb. 28, 2023 (FR) FR2301853

(51) Int. Cl. G01F 15/12; G01F 1/34; G01F 15/00; G01F 15/14

(52) U.S. Cl. CPC G01F 15/125; G01F 1/34; G01F 15/005; G01F 15/14

(57) ABSTRACT

Dust filter (12), arranged to be installed in a gas meter upstream of a measuring module measuring a flow rate of a gas, the filter (12) comprising a housing (20) inside which a first chamber (23) and a second chamber (24) are defined, the first chamber being located above the second chamber when the filter is installed in the meter, the housing comprising an inlet opening (28) and outlet openings (34) formed at the first chamber, a filtering medium (50) being installed in the first chamber, the filter is arranged such that, when installed in the meter, gas enters the filter via the inlet opening, passes through the filtering medium, and exits the filter via the outlet openings, dust particles contained in the gas are then deposited on the base of the second chamber (24).

The invention relates to the field of gas meters, and in particular, ultrasonic gas meters.

### BACKGROUND OF THE INVENTION

A gas meter will most usually comprise a measuring module intended to measure the flow rate of the gas that circulates in the meter.

However, it is known that the gases, whose flow rate is to be measured by using such a meter, transport a non-negligible quantity of various dust particles.

The measurements made by the measuring module of a gas meter may be disturbed by the presence of these dust particles. This is particularly the case for ultrasonic measuring modules.

It thus frequently happens that dust particles are deposited on the ultrasonic transducers and on the walls of the measuring duct in which the gas circulates and in which the transducers emit the ultrasonic signals. This phenomenon has the effect of disturbing the operation of the measuring module and affecting the accuracy of the meteorological measurements. The measurement error resulting from the presence of dust can be up to 4 to 5%.

A prior art solution is known, that proposes, to overcome this problem, integrating the measuring duct into an expanded chamber inside the meter, and causing the gas to circulate in the expanded chamber, before entering the measuring duct, by passing through a bent channel. The dust then falls by gravity into a dust collection area located in the expanded chamber outside the measuring duct.

However, since the dust collection area is very close to the inlet of the measuring duct, light dust tends to be drawn into the measuring duct when the gas flow rate is high, and may then settle on the transducers, and therefore tends to disturb the flow rate measurements achieved by the measuring module. That solution is therefore not satisfactory.

### AIM OF THE INVENTION

The invention aims to improve the accuracy of the gas flow rate measurements achieved by a gas meter, the gas carrying dust particles.

### SUMMARY OF THE INVENTION

In view of achieving this aim, a dust filter is proposed, arranged to be installed in a gas meter upstream of a measuring module that measures a flow rate of a gas, the filter comprising a housing inside which a first chamber and a second chamber are defined, the first chamber being located above the second chamber when the filter is installed in the meter, the housing comprising an inlet opening and outlet openings formed at the first chamber, a filtering medium being installed in the first chamber, the filter being arranged such that, when installed in the meter, gas enters the filter via the inlet opening, passes through the filtering medium, and exits the filter via the outlet openings, dust particles contained in the gas being then deposited on a base of the second chamber.

The dust filter therefore makes it possible to filter the dust contained in the gas.

The fall of heavy dust (by gravity) to the base of the second chamber is favoured by the relative positions of the first chamber and the second chamber. Lighter dust is filtered through the filtering medium. The dust is therefore trapped in the filter housing and cannot exit.

The filter is located upstream of the measuring module, such that all of the gas entering the measuring module has been previously filtered. The flow rate measurements are therefore very little disturbed by the presence of dust.

The filter may be positioned in the meter close to the gas inlet and at a distance from the measuring module, further limiting the entry of dust into the measuring module.

Optionally, the housing comprises a first casing inside which the first chamber is located and a second casing inside which the second chamber is located, which are fixed to each other, the first casing comprising an upper side in which the inlet opening is formed, and a first portion, of general cylindrical shape, in which the outlet openings are formed.

Optionally, the filter medium has a tubular shape comprising a hollow central portion and having a longitudinal axis that coincides with a longitudinal axis of the filter, the second casing comprising a second portion, of general cylindrical shape, and a lower side forming the base of the second chamber, the second casing further comprising a plurality of branches extending from a circumference of an end of the second portion opposite the lower side, the branches being parallel to a longitudinal axis of the filter, the filter being arranged, when assembled, such that the branches extend into the hollow central portion of the filtering medium by compressing the filtering medium against an inner wall of the first portion of the first casing.

Optionally, the first casing comprises tabs formed within the thickness of the first portion and along a length thereof, each tab extending from the upper side of the first casing to an end of the first casing opposite the upper side, the free end of each tab comprising a hook for securing the first casing and the second casing by a snap-fit system.

Optionally, the outlet openings comprise first openings adjacent to the tabs, and second openings not adjacent to the tabs, the first openings being wider than the second openings.

Optionally, said end of the second portion has a collar shape comprising holes into which the hooks of the tabs of the first casing engage.

Optionally, the upper side of the housing comprises a groove that surrounds the inlet opening and that is provided with radial projections arranged to secure the filter in the meter via a bayonet mounting.

Optionally, the filter additionally comprises a magnet positioned on the base of the second chamber and arranged to attract metal dust particles.

Optionally, the housing can be made of polyoxymethylene.

Optionally, the filtering medium can be a polyester medium.

The invention also relates to a gas meter comprising a measuring module arranged to measure a flow rate of a gas, and a dust filter as specified above, the filter being installed upstream of the measuring module such that all the gas entering the measuring module has been previously filtered by the filter.

Optionally, the meter comprises an inlet connector through which gas enters the meter and an outlet connector through which gas exits the meter, the meter being arranged such that, when the meter is installed in a nominal position, the inlet connector and the filter extending successively from top to bottom along a vertical axis, a measuring duct of the measuring module and the outlet connector extending successively from bottom to top along a second vertical axis.

Optionally, the meter further comprises an electromechanical valve positioned between the inlet connector and the filter, to which the filter is secured.

Optionally, the meter also comprises a pressure measuring device comprising a housing inside which a differential pressure sensor is integrated, the housing comprising a first pressure port opening into the second filter chamber and a second pressure port opening into a tank of the meter outside the filter.

Optionally, the meter comprises a processing unit arranged to compare, with a reference threshold, a pressure difference between a first pressure measurement produced by a first sensitive cell of the differential pressure sensor that is in fluid communication with the second chamber via the first pressure port and a second pressure measurement produced by a second sensitive cell of the differential pressure sensor that is in fluid communication with the tank via the second pressure port, and to produce an alarm message if the pressure difference is greater than said reference threshold.

The invention will be best understood in the light of the following description of particular non-limiting embodiments of the invention.

### BRIEF DESCRIPTION OF THE DRAWING

Reference will be made to the accompanying drawings, among which:

FIG. 1 is a view of the inside of a gas meter integrating the dust filter;

FIG. 2 shows a perspective view from above of the first casing, a view from above of the second casing, and a view of the assembled filter;

FIG. 3 is a perspective view of the first casing, the filtering medium and the second casing;

FIG. 4 is a graph comprising the curves of the measurement error as a function of the gas flow rate;

FIG. 5 is a view similar to FIG. 1, the dust filter integrating a magnet;

FIG. 6 is a cross-sectional view according to a vertical plan of a meter, which comprises a pressure measuring device;

FIG. 7 shows the pressure measuring device;

### DETAILED DESCRIPTION OF THE INVENTION

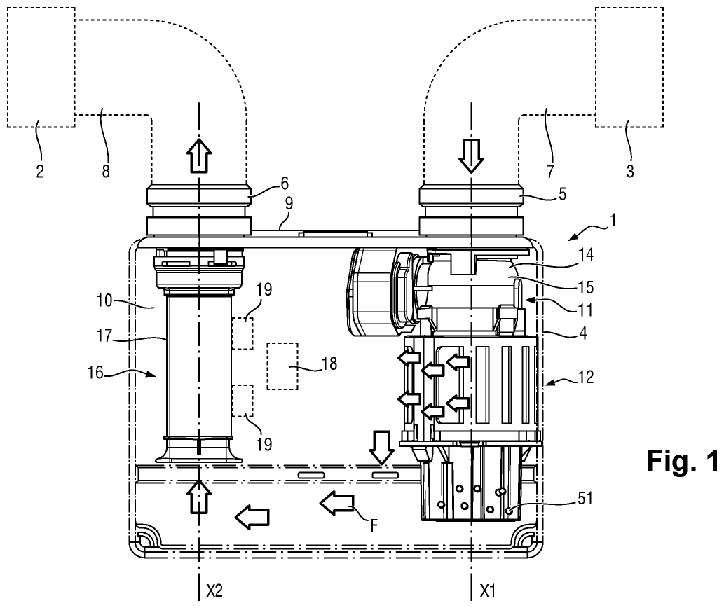

In reference to FIG. 1, the gas meter 1 is an ultrasonic “smart meter”. The meter 1 is used to measure the gas consumption of an installation 2. The gas is supplied to the installation by a distribution network 3.

The meter 1 comprises a housing 4 that consists of an input connector 5 and an output connector 6. The inlet connector 5 makes it possible to connect a pipe 7 to the meter 1 that connects the distribution network 3 to the meter 1. The outlet connector 6 makes it possible to connect a pipe 8 to the meter 1 that connects the meter 1 to the installation 2.

The position of the meter 1 shown in FIG. 1 is the nominal position of the meter 1, i.e. the operating position that it occupies when it is in service and positioned correctly. Within this text, each time that a positioning term is used regarding an object (upper, lower, etc.), it refers to the nominal position, in service, of that object.

The input connector 5 and the output connector 6 are located on an upper side 9 of the housing 4 of the meter 1.

A tank 10 is defined inside the housing 4.

The inlet connector 5 opens into the tank 10.

The meter 1 comprises an electromechanical valve 11 and a dust filter 12, which are positioned in the tank 10.

The electromechanical valve 11 is a ball valve that comprises a duct 14 and a ball 15 positioned in the duct 14. The angular position of the ball 15 can be controlled remotely, in order to cut off, limit or re-establish the gas flow rate supplied to the installation 2.

The valve 11 is connected to the input connector 5.

The dust filter 12 is described in detail below. When the meter 1 is positioned in its nominal position, the inlet connector 5, the duct 14 of the valve 11 and the filter 12 extend successively, from top to bottom, along a vertical axis X1.

The meter 1 also comprises a measuring module 16. The measuring module 16 comprises a measuring duct 17, a processing unit 18 and two ultrasonic transducers 19 (shown schematically in FIG. 1 and in positions not representative of reality).

The processing unit 18 is located outside the tank 10. It is integrated into an electronic card of the meter 1, that is not necessarily dedicated solely to flow rate measurement. The processing unit 18 comprises at least one processing component (electronic and/or software), which is, for example, a “general-purpose” processor, a processor specialising in signal processing (or DSP, Digital Signal Processor), a micro-controller, or a programmable logic circuit, such as an FPGA (Field Programmable Gate Array) or an ASIC (Application Specific Integrated Circuit). The processing unit 18 also comprises an excitation signal generator, and a signal receiver.

The measuring module 16 operates as follows. Each ultrasonic transducer 19 acts in succession as an emitter and as a receiver. The processing unit 18 generates an electrical excitation signal and applies it to the terminals of an emitter transducer. The emitter emits an ultrasonic signal into the measuring duct 17, which is captured by the receiver after having travelled a path of predefined length in the measuring duct 17. Then, the receiver transducer emits in turn an ultrasonic signal, that is captured by the other transducer after travelling the same path, in the opposite direction.

From the signals received, the processing unit 18 deduces the speed of the gas and therefore the flow rate of the gas.

The output of the measuring duct 17 is connected to the output connector 6.

The longitudinal axis of the measuring duct 17 is a vertical axis X2 parallel to the axis X1.

The measuring duct 17 and the outlet connector 6 extend successively, from bottom to top, along the axis X2.

The gas enters the meter 1 via the inlet connector 5. It passes into the duct 14 of the valve 11, then into the filter 12, then into the tank 10. It then enters the measuring duct 17 and exits the meter 1 via the outlet connector 6.

Now, attention is given to the dust filter 12.

The dust filter 12 is therefore installed in the meter 1 upstream of the measuring module 16. In this case, the terms “upstream” and “downstream” are defined with respect to the flow direction of the gas in the meter 1.

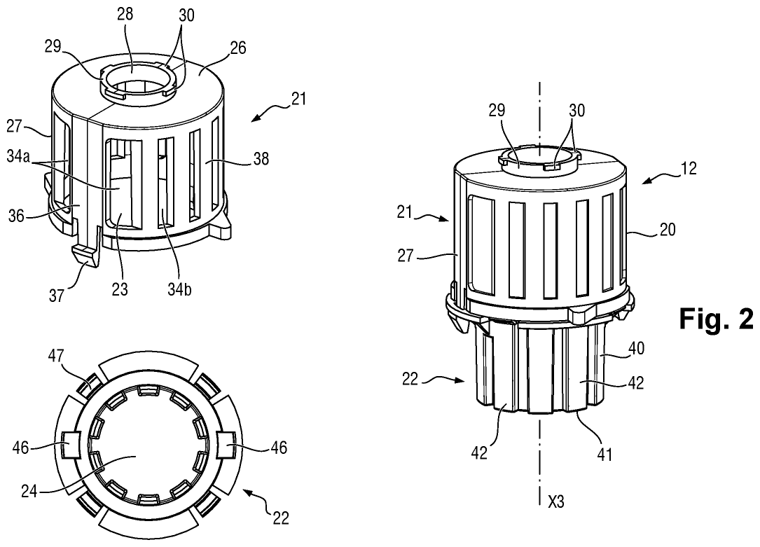

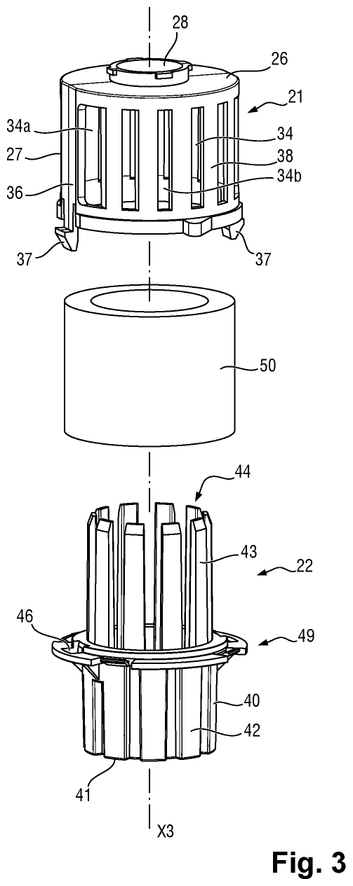

In reference to FIGS. 2 and 3, the filter 12 comprises a housing 20 comprising a first casing 21 and a second casing 22, which are two distinct casing elements.

A first chamber 23 and a second chamber 24 are located inside the housing 20. The first chamber 23 is located inside the first casing 21 and the second chamber 24 is located inside the second casing 21.

When the filter 12 is installed in the meter 1, the first casing 21, and therefore the first chamber 23, are located above the second casing 22, and therefore above the second chamber 24.

The first casing 21 comprises an upper side 26 and a first portion 27 of general cylindrical shape.

The upper side 26 comprises at its centre a circular hole 28 forming an inlet opening. A groove 29 of circular shape extends around the hole 28, at its circumference, projecting vertically from the upper side 26. A plurality of radial projections 30, in this example, four radial projections 30, regularly distributed, extend from a free end of the groove 29 towards the outside (opposite the hole 28).

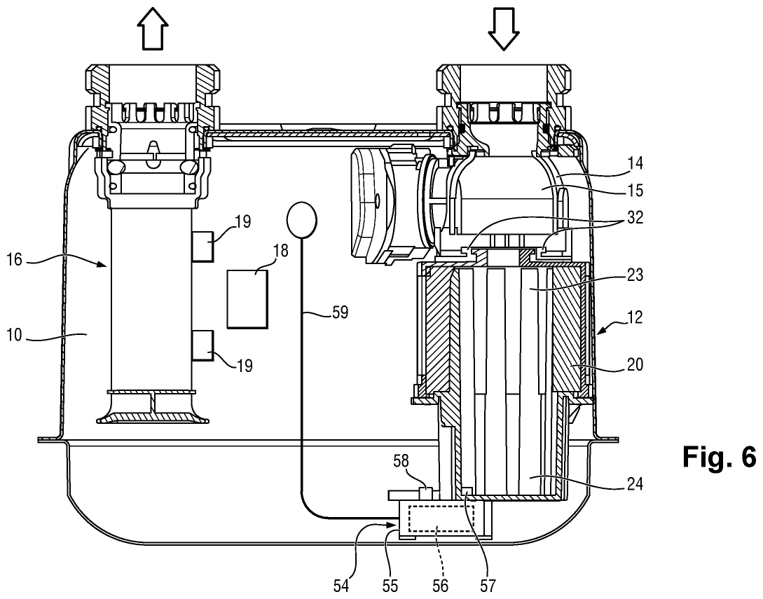

The lower end of the duct 14 of the valve 11 comprises, at its opening, recesses 32 (visible only in FIG. 6), in this example, four recesses 32, formed inside the duct 14 and which extend along a circumference of the opening.

The groove 29 and the radial projections 30 make it possible to secure the filter 12 to the lower end of the duct 14 via a bayonet mounting. To secure the filter 12 to the valve 11, the filter 12 is positioned under the valve 11, the radial projections 30 of the groove 29 of the first casing 21 are inserted into the recesses 32, and the filter 12 is rotated a quarter of a turn about its longitudinal axis X3 (which coincides with the axis X1 when the filter 12 is installed in the meter 1).

The housing 20 also comprises outlet openings 34 formed at the first chamber 23. The outlet openings 34 are formed in the first portion 27 (of general cylindrical shape). The outlet openings 34 are of longitudinal shape along a height of the first portion 27: the length of the outlet openings 34 is parallel to the axis X3. The outlet openings 34 are positioned around all of the first portion 27.

The first casing 21 further comprises a plurality of tabs 36, in this example, two tabs 36, formed within the thickness of the first portion 27 and along a length thereof. Each tab 36 extends from the upper side 26 of the first casing 21 to the free end of the first casing 21, opposite the upper side 26. The free end of each tab 36 comprises a hook 37 for securing the first casing 21 and the second casing 22 by a snap-fit system.

As can be seen in FIGS. 2 and 3, the outlet openings 34 are defined between bars 38 which extend from the upper side 26 of the first casing 21 to its free end. The outlet openings 34 are slots formed in the first portion 27 between the bars 38. The two tabs 36 also act as bars, but are wider than the other bars 36.

The outlet openings 34 comprise first openings 34a having an edge that is also an edge of a tab 36, and second openings 34b which do not have an edge which is also an edge of a tab 36. The second openings 34b are therefore defined between two bars 38 which are not tabs 36. The first openings 34a are wider than the second openings 34b.

The second casing 22 comprises a second portion 40, of general cylindrical shape and a lower side 41, forming the base of the second chamber 24, and therefore of the housing 20 of the filter 12. The second chamber 24 is located inside the second portion 40.

The second portion 40 comprises lateral reinforcements 42 which extend longitudinally along the height of the second portion 40.

The second casing 22 further comprises a plurality of branches 43 which extend from a circumference of one end 49 of the second portion 40 opposite the lower side 41, and which are distributed regularly over the circumference of said end 49. The branches 43 are parallel to the longitudinal axis of the second casing 22. The end portion 44 of each branch 43, at the free end of the branch 43, comprises an external surface sloping and inclined towards the free end such that the thickness of the end portion 44 is progressively reduced.

The end 49 of the second portion 40 of the second casing 22 has a collar shape that comprises two holes 46 and four recesses 47 which extend along the collar and therefore along the outer circumference of the end 49 of the second portion 40.

The filtering medium 50 has a tubular shape comprising a hollow central portion. Its longitudinal axis coincides with that of the first casing 21 and with the longitudinal axis X3 of the filter 12 when the filter 12 is assembled. The height of the filtering medium 50 is equal to that of the first portion 27 of the first casing 21.

The filter 12 is assembled as follows. The filtering medium 50 is engaged onto the second casing 22 such that the branches 43 of the second casing 22 are inserted into the hollow central portion of the filtering medium 50. The reduced thickness of the free ends of the branches 43 facilitates this insertion. Furthermore, the first casing 21 covers the filtering medium 50. The hooks 37 of the tabs 36 of the first casing 21 engage into the holes 46 of the collar of the second casing 22, that makes it possible to secure the first casing 21 and the second casing 22 together by a snap-fit system. The edge of the free end of the first casing 21 is positioned in the recesses 47.

When the filter 12 is assembled, the branches 43 compress the filtering medium 50 against the inner wall of the first portion 27 of the first casing 21.

Therefore, the filter 12 can be assembled easily and quickly, and no complex assembly machinery is required.

The filter 12 is integrated into the meter 1 by being secured to the valve 11 via the bayonet mounting. The bayonet mounting allows the filter 12 to be integrated easily and quickly into the meter 1 while having a lock security and a resistance to vibrations and drops.

The path of the gas in the meter is described more specifically, which follows the arrows F.

The gas, after having entered the meter 1, passes into the duct 14 of the valve 11 and then enters the filter 12 via the inlet opening 28 of the first casing 21 of the housing 20. It passes through the filtering medium 50 and exits the filter 12 via the outlet openings 34 of the first casing 21. The gas then spreads into the tank 10 and enters the measuring duct 17 of the measuring module 16. All of the gas that enters the measuring module 16 has therefore been filtered. The gas exits the meter 1 via the outlet opening 6.

The vertical position of the filter 12 and the positioning of the chambers 23, 24 one above the other favours the drop, to the base of the second chamber 24, of the heavy dust particles 51 contained in the gas.

The lightest dust particles are left in suspension and are filtered by the filtering medium 50.

As mentioned above, among the outlet openings 34, the first openings 34a, adjacent to the tabs 36, are wider than the second openings 34b, not adjacent to the tabs 36. This makes it possible to compensate for the loss of filtration resulting from the presence of the tabs 36, which are wider than the other bars 38. This thus improves filtration.

The second chamber 24, that forms a trap for dust, and in particular, for heavy dust, may trap up to 180 grammes of dust (knowing that the normative requirement is 20 grammes).

Now, attention is given to the materials used to make the filter 12.

The first casing 21 and the second casing 22 of the housing 20 are, in this case, both made of polyoxymethylene (or “POM”), that is a semi-crystalline thermoplastic. Other types of plastic may be used but POM has several advantages which make it perfectly suitable for use in a gas meter. The POM, for example:
has a good dimensional stability according to the temperature;
has a good resistance to aggressive chemicals (e.g., ammonia and sulphur);
has a high resistance to fatigue and wear;
is easily moulded: POM is easy to mould, making it an ideal material for precision mechanical parts.

In this example, the filtering medium 50 is a synthetic filtering medium.

The advantages of the synthetic filtering medium are:
a high resistance to abrasion and tearing;
a high particle retention capacity, that can be adjusted according to specific needs;
its ability to be used under extreme temperature and pressure conditions;
its low air resistance that allows a high air flow rate and a low pressure drop;
that this type of filtering medium is resistant to most chemicals and corrosive agents.

Of course, the performance of the filtering medium 50 will depend on several parameters, such as:
its thickness: from a few mm to a few cm;
pore size: it is important to choose a filter with a pore size small enough to retain metal dust particles. The filtering medium, in this example, has pores which are smaller in size than the actual particles to be filtered, i.e. smaller in size than 400 μ(the diameter of the metal dust particles present in the gas varies between 0.1 μm and 400 μm);
particle retention: it is also important to choose a filter that has a high particle retention capacity to effectively retain metal dust (for example: 400 g/m²);
the pressure drop according to the flow rate: it is important to choose a filter having a low air resistance to avoid the end consumer having to contend with drops in gas pressure (example: 0.0002 mbar/m³).

The filtering medium 50 chosen here is a synthetic filter medium with the following characteristics:
thickness: 8 mm;
composition: 100 polyester fibers;
class: G3 or G4;
dust retention capacity: 400 g/m²;
thermal stability: 100°° C.;
initial pressure drop: 0.0002 bar/m³.

Class G3 is a European standard used to classify air filters according to their filtration capacity. It indicates that the filter has a minimum filtration efficiency of 50% for particles from 0.3 to 1 micrometer. This means that if 100% of the particles of this size are present in the air, at least 50% will be retained by the filter.

Class G4 is a European standard used to classify air filters according to their filtration capacity. It indicates that the filter has a minimum filtration efficiency of 85% for particles from 0.3 to 1 micrometer. This means that if 100% of the particles of this size are present in the air, at least 85% will be retained by the filter.

Now, attention is given to the evaluation of the performances of the filter 12 that has been described and of its integration into the gas meter 1.

As mentioned above, the main disadvantage of the presence of dust is the degradation in the accuracy of gas flow rate measurement.

A normative dust resistance test was performed in a certified laboratory to evaluate the performance of the filter 12. This test consists of measuring the accuracy of the meter 1 in the presence of 20 grammes of dust (normative requirement).

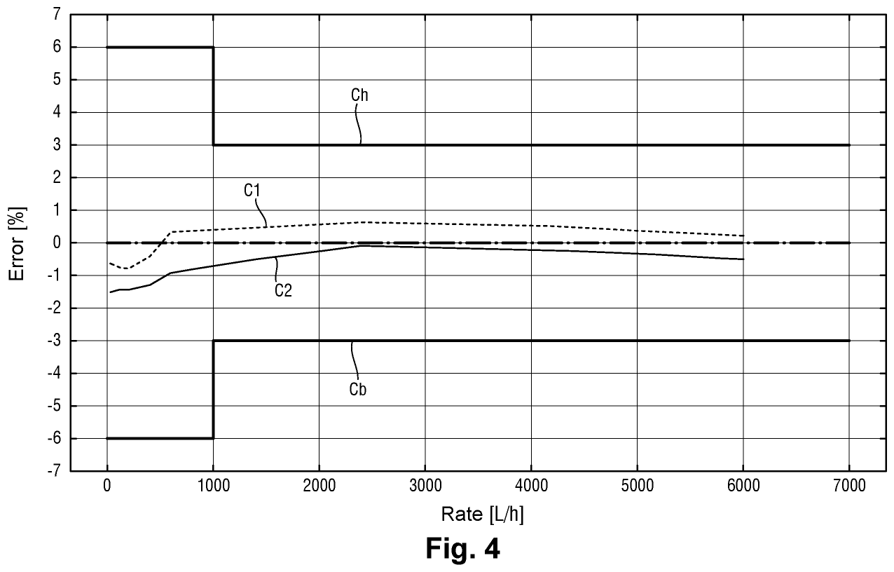

The results obtained from this new simulation can be seen in FIG. 4.

For the test to be successful, the curve of the error according to the flow rate must remain within a meteorological range defined by a high limit curve Ch and a low limit curve Cb.

The curve C1 shows the evolution of the error according to the flow rate before the normative dust resistance test, i.e. before the introduction of dust.

The curve C2 shows the evolution of the error according to the flow rate after the introduction of the dust. It can be seen that the test has very slightly degraded the accuracy. The meteorological error is degraded on average by 0.65% but remains within the meteorological range and is therefore in compliance with the standard.

It has also been verified that the presence of the filter does not cause any unacceptable pressure drop.

Indeed, in accordance with standard EN 14236, the meter must have a pressure drop of less than 2 mbar at the maximum flow rate. Standard EN 14236 is a European standard that defines the requirements for ultrasonic gas meters. This covers performance requirements, safety requirements, reliability requirements and electromagnetic compatibility requirements for ultrasonic gas meters. Performance requirements include measuring accuracy, measuring stability, operating temperature, operating pressure, electromagnetic compatibility and dust resistance, while safety requirements include electrical safety and fire safety requirements.

It should be recalled that type G6 meters have a minimum flow rate of 0.06 m³/h and a maximum flow rate of 10 m³/h. Type G4 meters have a minimum flow rate of 0.04 m³/h and a maximum flow rate of 6 m³/h. Type G6 meters are suitable for higher gas consumption than G4 meters.

The pressure drop may increase after the normative “dust resistance” test, but it must remain below 2.2 mbar at the maximum flow rate.

The reference pressure drop at Qmax (maximum flow rate) is: 1 mbar.

The pressure drop after the “dust resistance” test at Qmax (maximum flow rate) is: 1.05 mbar.

It is noted that the gap between the two pressure drops is negligible, which proves that the concept is validated and that the filter is not clogged.

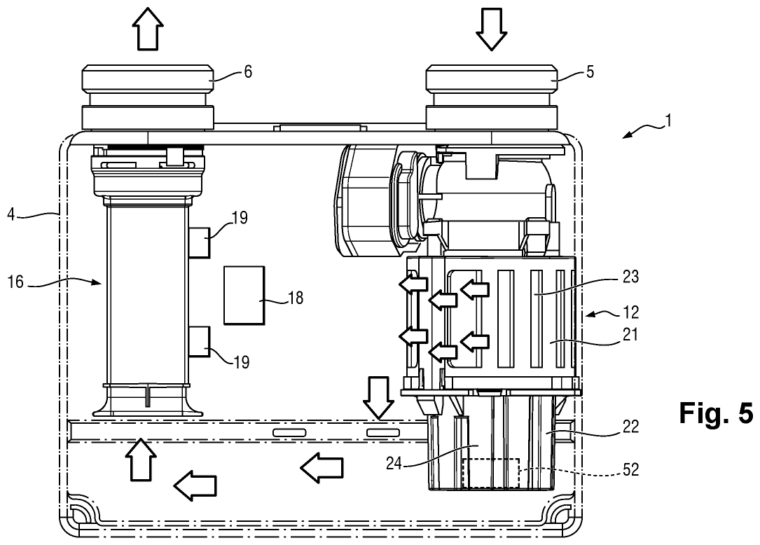

In a second embodiment, visible in FIG. 5, the filter comprises a magnet 52. It may also comprise a plurality of magnets 52.

Advantageously, the magnet(s) 52 are located in the second chamber 24. In this case, the filter 12 comprises a single magnet 52 that is positioned on the base of the second chamber 24, being glued to the latter. Any securing means may be used to secure the magnet(s).

Adding one or more magnets 52 in the second chamber 24 increases the performance of the filter 12 by increasing the retention force of dust particles. The magnet(s) 52 create a magnetic field that attracts metal dust particles, such as iron particles (knowing that 92% of the dust used for certification tests in a gas meter are iron particles).

These dust particles are then trapped by the filter 12, that increases its filtration efficiency. The magnets 52 can also help to reduce the pressure drop due to the accumulation of dust particles on the filter, that can also improve the performance of the filter.

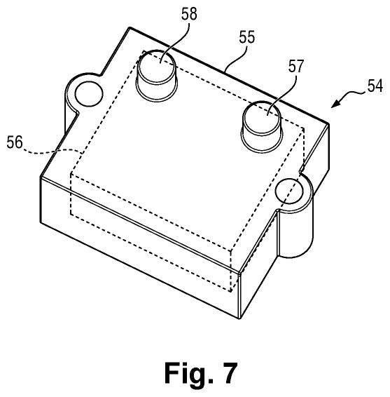

In a third embodiment, visible in FIGS. 6 and 7, the meter 1 integrates a pressure measuring device 54.

The pressure measuring device 54 comprises a housing 55 inside which a differential pressure sensor 56 is integrated. The housing 55 comprises an upper side consisting of a first pressure port 57 and a second pressure port 58. The housing 55 is positioned such that the first pressure port 57 opens into the second chamber 24 of the filter 12, and such that the second pressure port 58 opens into the tank 10 outside the filter 12 and downstream from the filter 12.

The differential pressure sensor 56 comprises a first sensitive cell that is in fluid communication with the second chamber 24 via the first pressure port 57, and a second sensitive cell that is in fluid communication with the tank 10 via the second pressure port 58.

Different types of sensors may be used to measure pressure, such as capacitive, piezoresistive or diaphragm sensors. In view of the low pressure that is intended to be measured, a MEMS-type differential pressure sensor will be used here, and for example, the model “MEMS Digital Differential Ultra Low Pressure Sensor FSP1000”, that has the following characteristics:
pressure range: 5 to 500 Pascals:
supply voltage: 3 to 5.5 Volts;
output: analogue or I2C bus;
precision: +2% of full scale;
humidity: <95%;
operating temperature: −20 to 70° C.

The differential pressure sensor 56 is connected to the processing unit 18 of the meter 1 (that is located outside the tank 10) by the wires 59.

The differential pressure sensor 56 makes it possible to measure the change in the pressure drop.

During the calibration of the meter 1, at the end of its manufacture, a first pressure measurement P1 performed by the first sensitive cell and a second pressure measurement P2 performed by the second sensitive cell are acquired for several flow rate values. The pressure drop is then calculated (ΔP: P1-P2) for each flow rate value.

These pressure drop values ΔP will be used as a reference to be able to follow the evolution of the pressure drop during the service life of the meter 1.

For example, the reference pressure drop ΔP0 at 10000 l/h, measured during the calibration of the meter 1, is, for example, equal to 1 mbar.

If the filter 12 becomes clogged over time, this pressure drop will therefore increase and risk exceeding a reference threshold (for example: ΔP=2 mbar)

This information may be used to alert the customer to the quality of its network and the risk of clogging and pressure drop within meter 1.

The processing unit 18 compares, with a reference threshold, a pressure difference between a first pressure measurement produced by the first sensitive cell and a second pressure measurement produced by the second sensitive cell, and produces an alarm message if the pressure difference is greater than said reference threshold.

Naturally, the invention is not limited to the embodiment described, but covers any variant coming within the scope of the invention as defined by the claims.

The shape of the filter and that of the diverse components constituting it (casings, openings, securing means, filtering medium, etc.) may of course be different from those described in this case. The housing may be formed as a single piece and therefore comprise a single casing in which the first chamber and the second chamber are defined.

When the filter is integrated into the meter, its longitudinal axis is not necessarily positioned vertically; it may be inclined relative to the vertical.

The materials used for the filtering medium and the housing may be different from those described here.

1. A dust filter, arranged to be installed in a gas meter upstream of a measuring module that measures a flow rate of a gas, the filter comprising a housing inside which a first chamber and a second chamber are defined, the first chamber being located above the second chamber when the filter is installed in the meter, the housing comprising an inlet opening and outlet openings formed at the first chamber, a filtering medium being installed in the first chamber, the filter being arranged such that, when installed in the meter, gas enters the filter via the inlet opening, passes through the filtering medium, and exits the filter via the outlet openings, dust particles contained in the gas being then deposited on the base of the second chamber, the housing comprising a first casing inside which the first chamber is located and a second casing inside which the second chamber is located, which are secured to each other, the first casing comprising an upper side wherein the inlet opening is formed, and a first portion, of general cylindrical shape, wherein the outlet openings are formed.

2. The dust filter according to claim 1, the filtering medium having a tubular shape comprising a hollow central portion and having a longitudinal axis that coincides with a longitudinal axis of the filter, the second casing comprising a second portion, of general cylindrical shape, and a lower side forming the base of the second chamber, the second casing further comprising a plurality of branches extending from a circumference of an end of the second portion opposite the lower side, the branches being parallel to a longitudinal axis of the filter, the filter being arranged, when assembled, such that the branches extend into the hollow central portion of the filtering medium by compressing the filtering medium against an inner wall of the first portion of the first casing.

3. The dust filter according to claim 1, the first casing comprising tabs formed within the thickness of the first portion and along a length thereof, each tab extending from the upper side of the first casing to an end of the first casing opposite the upper side, the free end of each tab comprising a hook making it possible to secure the first casing and the second casing by a snap-fit system.

4. The dust filter according to claim 3, wherein the outlet openings comprise first openings adjacent to the tabs, and second openings not adjacent to the tabs, the first openings being wider than the second openings.

5. The dust filter according to claim 2, wherein said end of the second portion has a collar shape comprising holes into which the hooks of the tabs of the first casing engage.

6. The dust filter according to claim 1, wherein the upper side of the housing has a groove that surrounds the inlet opening and that is provided with radial projections arranged to secure the filter in the meter via a bayonet mounting.

7. The dust filter according to claim 1, further comprising a magnet positioned on the base of the second chamber and arranged to attract metal dust particles.

8. The dust filter according claim 1, the housing being made of polyoxymethylene.

9. The dust filter according to claim 1, the filter medium being a polyester medium.

10. A gas meter comprising a measuring module arranged to measure a flow rate of a gas, and the dust filter according to claim 1, the filter being installed upstream of the measuring module so that all the gas entering the measuring module has been previously filtered by the filter.

11. The gas meter according to claim 10, comprising an inlet connector through which gas enters the meter and an outlet connector through which gas exits the meter, the meter being arranged such that when the meter is installed in a nominal position, the inlet connector and the filter extend successively from top to bottom along a vertical axis (X1), a measuring duct of the measuring module and the outlet connector extending successively from bottom to top along a second vertical axis.

12. The gas meter according to claim 11, further comprising an electromechanical valve positioned between the inlet connector and the filter, to which the filter is secured.

13. The gas meter according to claim 10, further comprising a pressure measuring device comprising a housing inside which a differential pressure sensor is integrated, the housing comprising a first pressure port opening into the second chamber of the filter and a second pressure port opening into a tank (10) of the meter outside the filter.

14. The gas meter according to claim 13, the meter comprising a processing unit arranged to compare, with a reference threshold, a pressure difference between a first pressure measurement produced by a first sensitive cell of the differential pressure sensor that is in fluid communication with the second chamber via the first pressure port and a second pressure measurement produced by a second sensitive cell of the differential pressure sensor that is in fluid communication with the tank via the second pressure port, and to produce an alarm message if the pressure difference is greater than said reference threshold.
